(19) United States
(12) Patent Application Publication
(10) Pub. No.: US 2025/0363800 A1
(43) Pub. Date: Nov. 27, 2025

(54) PARKING AREA EXTRACTION DEVICE, PARKING AREA EXTRACTION METHOD, AND PARKING AREA EXTRACTION PROGRAM

(71) Applicant: NIPPON TELEGRAPH AND TELEPHONE CORPORATION, Tokyo (JP)

(72) Inventors: Kohei MORI, Tokyo (JP); Kenichi FUKUDA, Tokyo (JP); Yukio KIKUYA, Tokyo (JP); Masato KAMIYA, Tokyo (JP)

(73) Assignee: NIPPON TELEGRAPH AND TELEPHONE CORPORATION, Tokyo (JP)

(21) Appl. No.: 18/874,739

(22) PCT Filed: Jul. 7, 2022
(86) PCT No.: PCT/JP2022/026969

§ 371 Date: Dec. 13, 2024

(51) Int. Cl. G06V 20/17; G06V 10/25; G06V 10/776

(52) U.S. Cl. CPC G06V 20/17; G06V 10/25; G06V 10/776; G06V 2201/08

(57) ABSTRACT

A parking region extraction apparatus is a parking region extraction apparatus for extracting a parking region which is a region for parking a vehicle in a site, and includes an acquisition unit that acquires map information including the site, an extraction unit that extracts candidates for the parking region by dividing the site using the map information, and an estimation unit that derives an accuracy of each of the candidates and estimate the parking region.

### TECHNICAL FIELD

The technology of the disclosure relates to a parking region extraction apparatus, a parking region extraction method, and a parking region extraction program.

### BACKGROUND ART

In recent years, for the purpose of realizing automatic driving of vehicles, there has been actively developed a technique for generating map information (dynamic map) including highly accurate three-dimensional geographical space information capable of discriminating a self-position at a lane level and a road condition such as traffic congestion and accidents. The map information can be created by using results of performing measurement on the vicinity of a road by using cameras and sensors when a traveling vehicle travels on each of roads.

The map information includes not only roads but also parking lots for parking vehicles. For the map information in the parking lot, it is important to ascertain a region and shape of the parking lot as map information in order to alert users when driving a vehicle or walking in the parking lot. When map information for a parking lot is created, the map information for the parking lot is created by using static map information, and cameras and sensors installed in the parking lot.

### CITATION LIST

### Non Patent Literature

[NPL 1] Keiichi Yamada, Morimichi Mizuno, Arata Yamamoto, Katsuaki Murano, Shuichi Sunahara “Parking lot situation monitoring system using images”, Transactions of the Institute of Electronics Engineers C, Vol. 120, No. 6, 2000, P784-790<URL: https://www.jstage. jst.go.jp/article/ieejeiss1987/120/6/120_6_784/_pdf>

A technique for detecting the presence or absence of a vehicle for each parking space in a parking lot by using an image captured by a camera installed at a high place in the parking lot is disclosed in NPL 1.

### SUMMARY OF INVENTION

### Technical Problem

However, when a camera and a sensor are not installed in the parking lot, map information in the parking lot may not be created.

The present disclosure has been made in view of such a circumstance, and an object of the present disclosure is to provide a parking region extraction apparatus, a parking region extraction method, and a parking region extraction program capable of creating map information in a parking lot even when a camera and a sensor are not installed in the parking lot.

### Solution to Problem

A first aspect of the present disclosure is a parking region extraction apparatus for extracting a parking region which is a region for parking a vehicle in a site, the parking region extraction apparatus including an acquisition unit configured to acquire map information including that of the site; an extraction unit configured to extract candidates for the parking region by dividing the site using the map information; and an estimation unit configured to derive an accuracy of each of the candidates and estimate the parking region.

A second aspect of the present disclosure is a parking region extraction method for extracting a parking region that is a region for parking a vehicle in a site, the parking region extraction method including: acquiring map information including the site; dividing the site using the map information and extracting candidates for the parking region; and deriving an accuracy of each of the candidates and estimating the parking region.

A third aspect of the present invention is a parking region extraction program for causing a computer to function as the parking region extraction apparatus according to the first aspect.

### Advantageous Effects of Invention

According to the disclosed technique, even when a camera and a sensor are not installed in the parking lot, the map information in the parking lot can be created.

### BRIEF DESCRIPTION OF DRAWINGS

FIG. 1 is a block diagram illustrating a hardware configuration of a parking region extraction apparatus according to the present embodiment.

FIG. 2 is a block diagram illustrating an example of a functional configuration of the parking region extraction apparatus according to the present embodiment.

FIG. 3 is a data flow diagram illustrating an example of a data flow of extraction processing provided to describe extraction of a parking region according to the present embodiment.

FIG. 4 is a schematic diagram illustrating an example of map information provided to explain a target range according to the present embodiment.

FIG. 5 is a schematic diagram illustrating an example of map information provided to explain extraction of parking region candidates according to the present embodiment.

FIG. 6 is a schematic diagram showing an example of map information provided to explain extraction of the parking region according to the present embodiment.

FIG. 7 is a flowchart illustrating an example of parking region extraction processing according to the present embodiment.

FIG. 8 is a flowchart illustrating an example of boundary line setting processing according to the present embodiment.

FIG. 9 is a flowchart illustrating an example of candidate estimation processing according to the present embodiment.

### Description of Embodiments

Hereinafter, an example of a mode for carrying out the present disclosure will be described in detail with reference to the drawings.

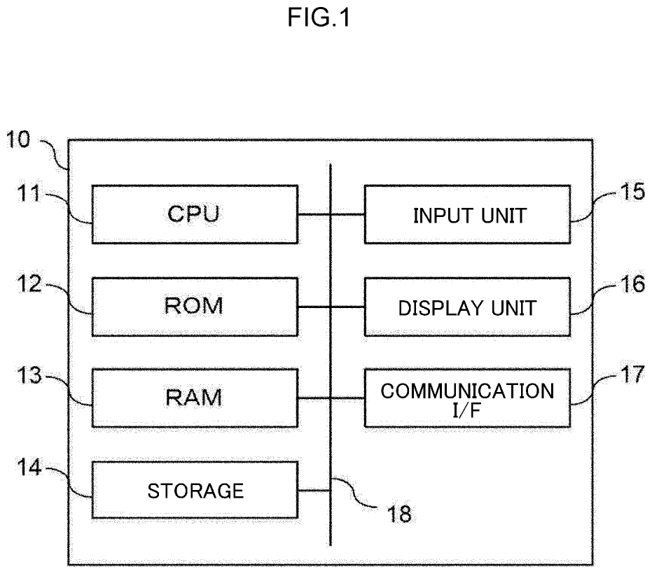

First, a hardware configuration of the parking region extraction apparatus 10 according to the present embodiment will be described with reference to FIG. 1. FIG. 1 is a block diagram illustrating a hardware configuration of the parking region extraction apparatus 10 according to the present embodiment.

As illustrated in FIG. 1, the parking region extraction apparatus 10 includes a central processing unit (CPU) 11, a read only memory (ROM) 12, a random access memory (RAM) 13, a storage 14, an input unit 15, a display unit 16, and a communication interface (I/F) 17. The respective components are connected via a bus 18 to be able to communicate with each other. The configuration using the CPU and the memory above described is merely an example, and for example, the configuration may be implemented as an apparatus that specializes in detection of objects having a dedicated arithmetic circuit mounted thereon.

The CPU 11 is a central processing unit and executes various programs and controls each unit. That is, the CPU 11 reads the program from the ROM 12 or the storage 14 and executes the program by using the RAM 13 as a work region. The CPU 11 performs control of each component and performs various types of arithmetic processing according to the programs stored in the ROM 12 or the storage 14. In the present embodiment, the ROM 12 or the storage 14 stores a parking region extraction program for extracting a region for parking a vehicle (hereinafter referred to as a “parking region”).

The ROM 12 stores various programs and various types of data. The RAM 13 temporarily stores programs or data as a work region. The storage 14 includes a storage device such as a hard disk drive (HDD) or a solid state drive (SSD), and stores various programs including an operating system and various types of data.

The input unit 15 includes a pointing device such as a mouse or a keyboard, and is used for various inputs.

The display unit 16 is, for example, a liquid crystal display, and displays various types of information. A touch panel scheme may be employed so that the display unit 16 may function as the input unit 15.

The communication interface 17 is an interface for communicating with another device such as a display device. In the communication, a wired communication standard such as Ethernet (registered trademark) or FDDI or a wireless communication standard such as 4G, 5G, and WiFi (registered trademark) is used. The communication interface 17 acquires input data from an external memory and transmits output data to the external memory.

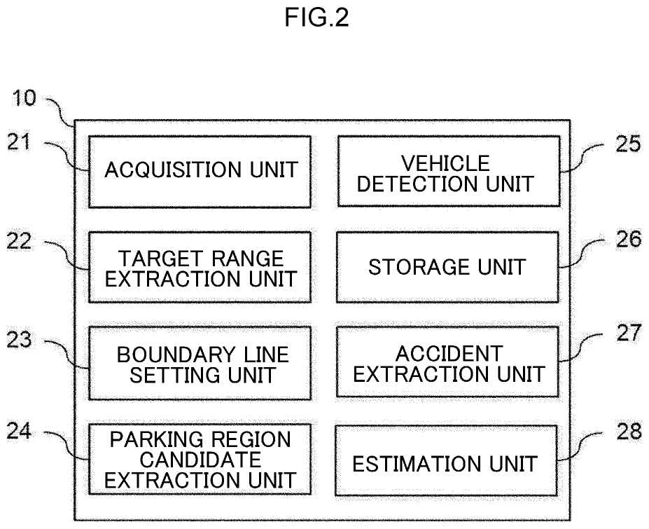

Next, a configuration of the parking region extraction apparatus 10 will be described with reference to FIG. 2. FIG. 2 is a block diagram illustrating an example of a functional configuration of the parking region extraction apparatus 10 according to the present embodiment.

As illustrated in FIG. 2, the parking region extraction apparatus 10 includes, as a functional configuration, an acquisition unit 21, a target range extraction unit 22, a boundary line setting unit 23, a parking region candidate extraction unit 24, a vehicle detection unit 25, a storage unit 26, an accident extraction unit 27, and an estimation unit 28. The CPU 11 executes the parking region extraction program to function as the acquisition unit 21, the target range extraction unit 22, the boundary line setting unit 23, the parking region candidate extraction unit 24, the vehicle detection unit 25, the storage unit 26, the accident extraction unit 27, and the estimation unit 28.

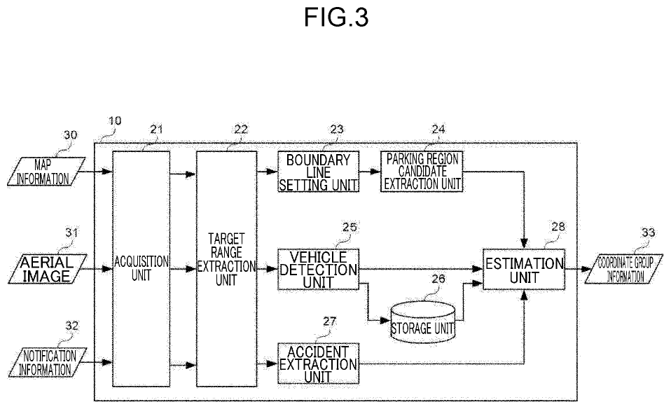

As illustrated in FIG. 3, for example, the acquisition unit 21 acquires map information 30, an aerial image 31, and notification information 32. The map information 30 is information indicating a road structure (feature) including boundaries of railroads, rivers, roads, sidewalks, sites, and the like, and buildings. A mode in which the map information according to the present embodiment is polygon information indicating the road structure (feature) as a group of points indicating latitude and longitude will be described. Further, a mode in which the map information is information in which railroads, rivers, roads, sidewalks, buildings, and the like are distinguished by type will be described. The aerial image 31 is, for example, a captured image obtained by photographing the ground surface from the sky using an aircraft, an artificial satellite, or a drone. The notification information 32 is information for notifying of an accident by a vehicle and indicating a position at which an accident has occurred.

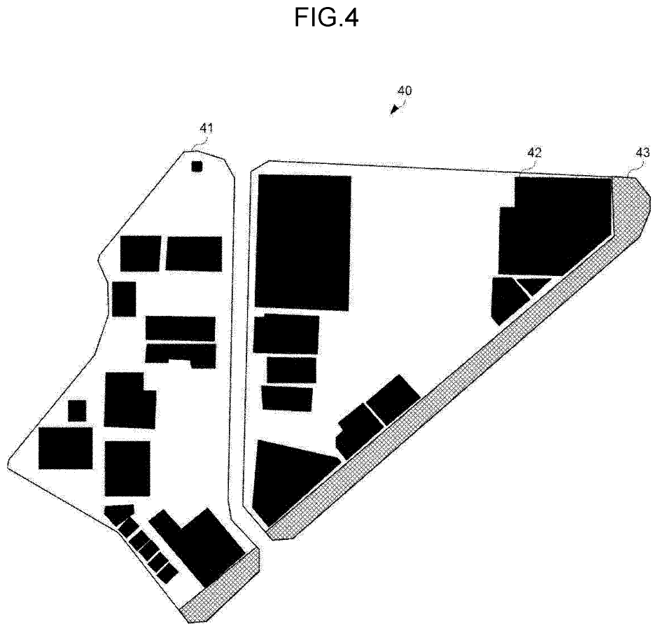

The target range extraction unit 22 extracts the target range for determining whether or not there is a parking region. For example, the target range extraction unit 22 extracts a destination or a site located around the host vehicle as the target range. As an example, as illustrated in FIG. 4, the target range extraction unit 22 extracts the site as the target range 40 by using map information. The target range extraction unit 22 identifies and extracts the boundary line 41 of the site, the building 42, and the sidewalk 43 as a result of extracting the target range 40. Here, the boundary line 41 of the site is a line for partitioning off a road, a sidewalk, a railroad, or the like, and the site indicates a region surrounded by the boundary line.

In the present embodiment, a mode in which a destination or a site located around the host vehicle is extracted as the target range 40 will be described. However, the present disclosure is not limited thereto. For example, the site designated by the user may be set as the target range 40.

The boundary line setting unit 23 sets a boundary line for dividing the target range 40 in order to extract the parking region in the target range 40. Specifically, a boundary line connecting the boundary line 41 of the site, the building 42, and the sidewalk 43 is derived and set.

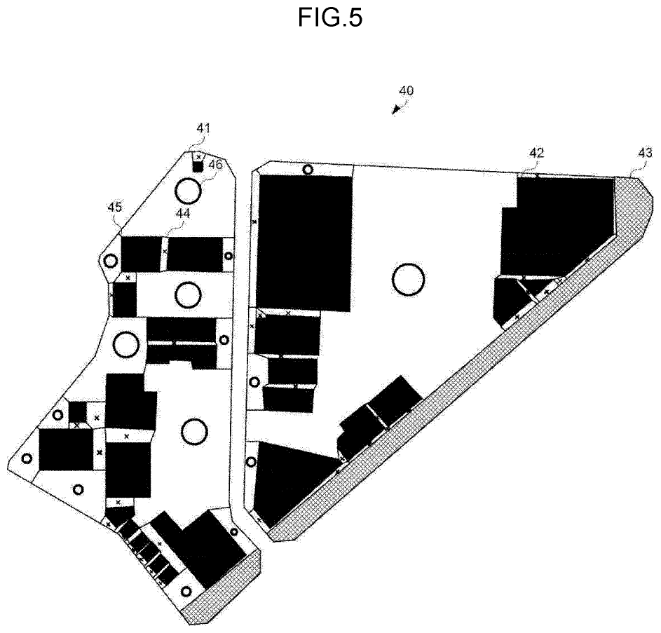

As an example, as illustrated in FIG. 5, the boundary line setting unit 23 first derives the boundary line 44 connecting each vertex of the building 42 to a vertex of another building 42 located nearest to the building 42. Here, the boundary line setting unit 23 excludes the boundary line 44 exceeding a predetermined length (for example, 3 m) through which the vehicle can pass. In other words, when the derived boundary line 44 is equal to or less than a predetermined length, the derived boundary line 44 is set as the boundary line 44.

Next, the boundary line setting unit 23 derives and sets a shortest perpendicular line 45 for the boundary line 41 of the site, the building 42, or the sidewalk 43 from the apex of the building 42 for which the boundary line 44 is not set. When the derived perpendicular line 45 exceeds a predetermined length (for example, 3m), the perpendicular line 45 is excluded. In other words, when the derived perpendicular line 45 is equal to or less than a predetermined length (for example, 3 m), the perpendicular line 45 is set.

Further, the boundary line setting unit 23 derives and sets the shortest perpendicular line 45 for the boundary line 41 of the site, the building 42, and the sidewalk 43 from the apex of the building 42 in which the boundary line 44 has been set. Here, when the derived perpendicular line 45 exceeds a predetermined length (for example, 1.5 m), the perpendicular line 45 is excluded. In other words, when the derived perpendicular line 45 is equal to or less than a predetermined length, the derived perpendicular line 45 is set as the perpendicular line 45.

As illustrated in FIG. 5, for example, the parking region candidate extraction unit 24 extracts a candidate for the parking region (hereinafter referred to as “parking region candidate”) 46. Specifically, when a region surrounded by the boundary line 41 of the site, the building 42, the sidewalk 43, the boundary line 44, and the perpendicular line 45 does not face the boundary line 41 (road) of the site or the sidewalk 43, the parking region candidate extraction unit 24 excludes the region from the parking region candidate 46. Further, the parking region candidate extraction unit 24 excludes the region surrounded by the boundary line 41 of the site, the building 42, the sidewalk 43, the boundary line 44, and the perpendicular line 45 from the parking region candidate 46 when the region has an area equal to or less than a predetermined area. In other words, when the region surrounded by the boundary line 41 of the site, the building 42, the sidewalk 43, the boundary line 44, and the perpendicular line 45 faces the boundary line 41 (road) of the site or the sidewalk 43 and exceeds a predetermined area, the parking region candidate extraction unit 24 extracts the area as the parking region candidate 46. In the present embodiment, a mode in which the parking region candidate 46 is extracted according to the position of the target region and the area of the target region has been described. However, the present disclosure is not limited thereto. The parking region candidate 46 may be extracted according to a circumscribed rectangle of the target region. For example, when an aspect ratio of the circumscribed rectangle of the target region is within a predetermined range, the parking region candidate 46 may be extracted.

The vehicle detection unit 25 detects a vehicle included in the target range 40 by using the aerial image 31, and outputs a position of the detected vehicle as a detection result.

The storage unit 26 stores the result of calculation obtained by the vehicle detection unit 25.

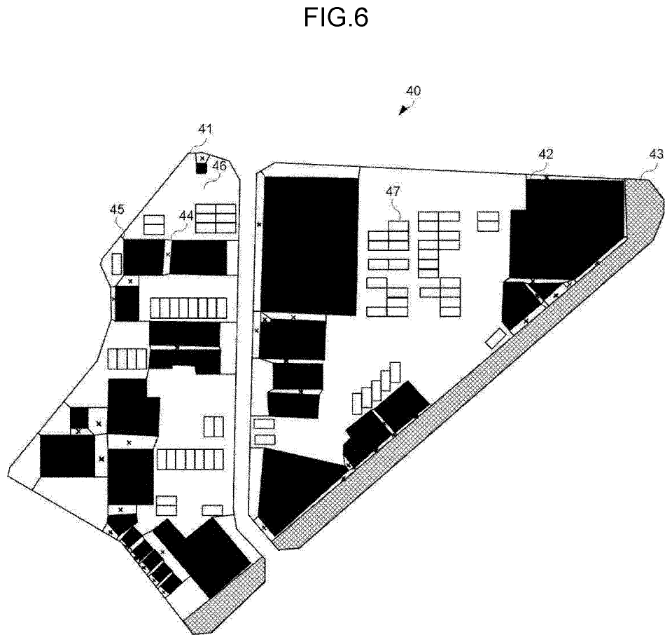

The accident extraction unit 27 extracts an accident occurring in the target range 40 by using the notification information, and outputs a position at which the accident occurs as an extraction result. In the present embodiment, a mode of extracting a position at which an accident has occurred as an extraction result will be described. However, the present disclosure is not limited thereto. As the extraction result, the amount of change in the occurrence of the accident in the target range 40 and the type of the accident may be included. The estimation unit 28 extracts the parking region from the parking region candidate 46 by using the detection result of the vehicle detection unit 25 and the extraction result of the accident extraction unit 27. Specifically, as illustrated in FIG. 6 as an example, the estimation unit 28 causes the detected positions of the respective vehicles 47 to correspond to the parking region candidates 46, derives the number of vehicles 47 with respect to the area related to the parking region candidates 46 (hereinafter, “vehicle density”), and derives the accuracy corresponding to the vehicle density. For example, the estimation unit 28 increases the accuracy in the parking region candidate 46 when the vehicle density is larger.

Further, the estimation unit 28 corrects the accuracy using the extraction result of the accident extraction unit 27. Specifically, the estimation unit 28 derives the number of notifications for the area related to the parking region candidate 46 (hereinafter referred to as “notification density”) using the extraction result, and corrects the accuracy according to the notification density. For example, the estimation unit 28 corrects the accuracy so that, when the notification density is higher, the accuracy in the parking region candidate 46 increases. Further, the estimation unit 28 may correct the accuracy so that the accuracy increases as the amount of change in the occurrence of the accident becomes larger, or correct the accuracy so that the accuracy increases depending on a type of the accident (for example, a contact accident between vehicles, a personal accident, a loss accident, or the like).

Further, the estimation unit 28 corrects the accuracy of the parking region candidate 46 using the currently detected detection result and the previously detected detection result. For example, the number of vehicles 47 may vary depending on time when the aerial image 31 has been captured (weekdays, holidays, presence or absence of events, long vacation, or the like) and a time zone (dawn, daytime, night, or the like). Therefore, the estimation unit 28 compares the estimation result based on the detection result obtained by actually detection with the estimation result based on the detection results obtained in the past according to the time series of the aerial images 31, and corrects the accuracy of the parking region candidate 46.

For example, when the vehicle 47 is no longer extracted after a certain period of time, the estimation unit 28 corrects the accuracy to reduce the accuracy as a closed parking lot. Furthermore, when the vehicle 47 has not been extracted for a period of time, but the vehicle 47 is extracted from a certain period, the estimation unit 28 assumes that the region is a newly established parking lot and corrects the accuracy to increase the accuracy. Furthermore, when the vehicle 47 is not extracted at dawn, but is extracted during the day, the estimation unit 28 estimates that the parking region is a parking region where the period in which parking is possible is limited is limited, and corrects the accuracy according to a time zone.

The estimation unit 28 determines that the parking region candidate 46 whose accuracy exceeds a predetermined threshold (for example, 80%) among the parking region candidates 46 is a parking region (parking lot), and outputs coordinates indicating a position of the region as coordinate group information 33. In the present embodiment, a mode in which coordinates indicating the position of the region are output as coordinate group information will be described. However, the present disclosure is not limited thereto. The accuracy related to each parking region may be output together with the coordinates.

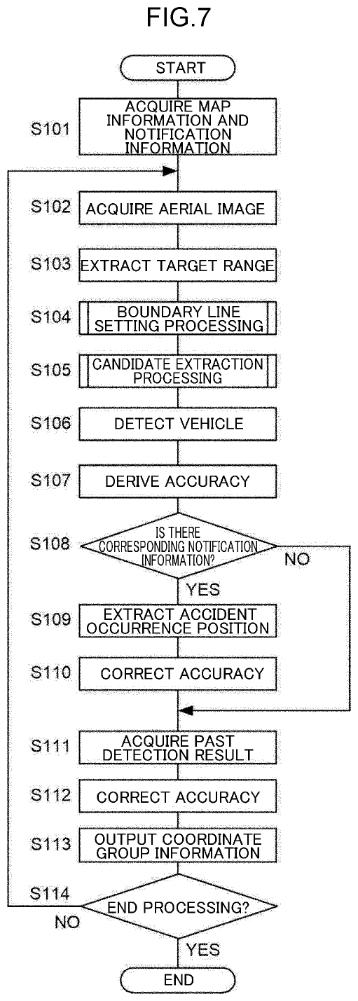

Next, an operation of the parking region extraction apparatus 10 according to the present embodiment will be described with reference to FIG. 7. FIG. 7 is a flowchart illustrating an example of parking region extraction processing according to the present embodiment. The parking region extraction program illustrated in FIG. 7 is executed by the CPU 11 reading the parking region extraction program from the ROM 12 or the storage 14 and executing the program. The parking region extraction program illustrated in FIG. 7 is executed, for example, when an instruction to execute parking region extraction processing is input.

In step S101, the CPU 11 acquires the map information 30 and the notification information 32.

In step S102, the CPU 11 acquires the aerial image 31.

In step S103, the CPU 11 extracts the target range 40 by using the map information 30.

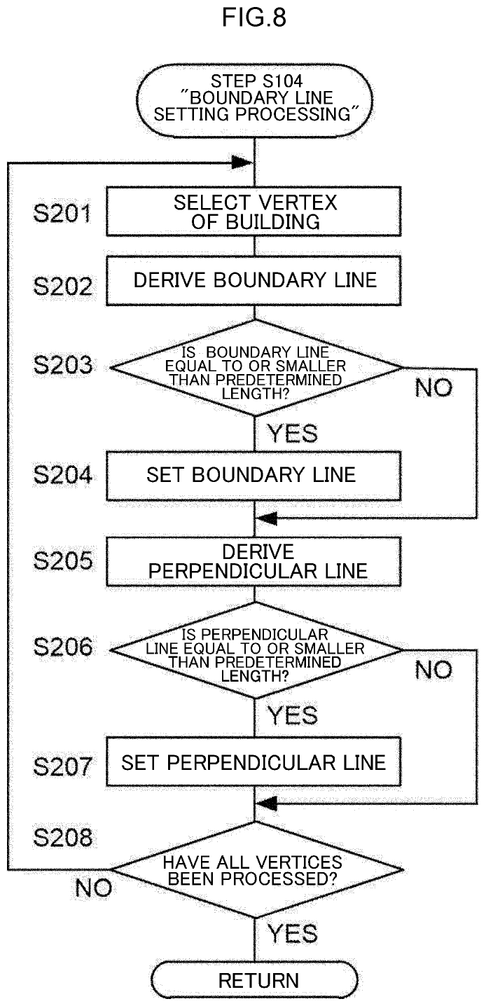

In step S104, the CPU 11 executes boundary line setting processing for setting the boundary line 44 and the perpendicular line 45 for the target range 40 in the map information 30. The boundary line setting processing will be described in detail with reference to FIG. 8, which will be described below.

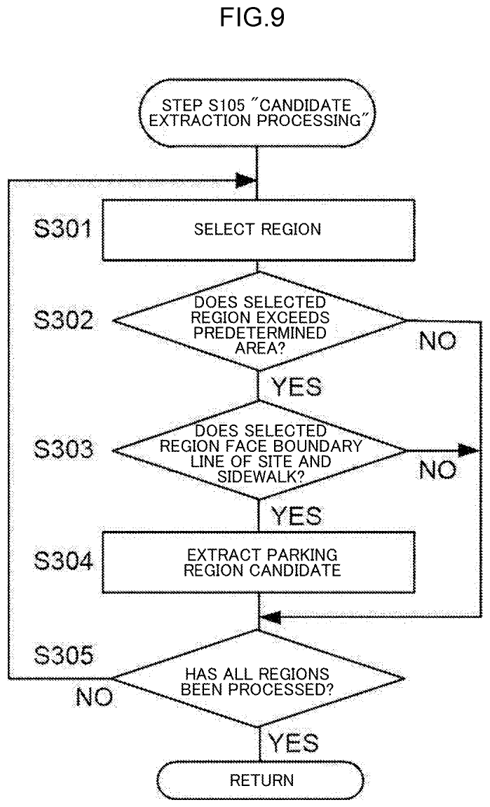

In step S105, the CPU 11 executes a candidate extraction processing for extracting the parking region candidates 46 from the region surrounded by the boundary line 41 of the site, the building 42, the sidewalk 43, the boundary line 44, and the perpendicular line 45. The candidate estimation processing will be described in detail with reference to FIG. 9 to be described below.

In step S106, the CPU 11 detects a position of the vehicle 47 included in the target range 40 by using the aerial image 31.

In step S107, the CPU 11 derives vehicle density related to each parking region candidate 46, and derives the accuracy of the parking region candidate 46 according to the vehicle density.

In step S108, the CPU 11 determines whether or not there is the notification information 32 corresponding to the target range 40 in the notification information 32. When is there the corresponding notification information 32 (step S108: Yes), the CPU 11 proceeds to step S109. On the other hand, when the corresponding notification information 32 does not exist (step S108: NO), the CPU 11 proceeds to step S111.

In step S109, the CPU 11 extracts notification information 32 corresponding to the target range 40.

In step S110, the CPU 11 derives a notification density related to each parking region candidate 46, and corrects the accuracy of the parking region candidate 46 according to the notification density.

In step S111, the CPU 11 acquires a detection result obtained in the past.

In step S112, the CPU 11 corrects the accuracy of the parking region candidate 46 using the currently detected detection result and the previously detected detection result.

In step S113, the CPU 11 outputs the parking region candidate 46 whose accuracy exceeds a predetermined threshold as coordinate group information.

In step S114, the CPU 11 determines whether to end the processing. When the processing ends (step S114: YES), the CPU 11 ends parking region extraction processing. On the other hand, when the processing does not end (step S114: No), the CPU 11 proceeds to step S102.

Next, the boundary line setting processing according to the present embodiment will be described with reference to FIG. 8. FIG. 8 is a flowchart illustrating an example of the boundary line setting processing according to the present embodiment. When the CPU 11 reads the boundary line setting program from the ROM 12 or the storage 14 and executes the boundary line setting program, the boundary line setting program shown in FIG. 8 is executed. The boundary line setting program shown in FIG. 8 is executed, for example, when an instruction to execute boundary line setting processing is input.

In step S201, the CPU 11 selects the vertex of the building 42.)

In step S202, the CPU 11 derives the boundary line 44 that connects the apex of the selected building 42 to the apex of another closest building 42.

In step S203, the CPU 11 determines whether the derived boundary line 44 is less than or equal to a predetermined length. When the derived boundary line 44 is equal to or less than a predetermined length (step S203: Yes), the CPU 11 proceeds to step S204. On the other hand, when the derived boundary line 44 is not equal to or less than the predetermined length (exceeds the predetermined length) (step S203: No), the CPU 11 proceeds to step S205.

In step S204, the CPU 11 sets the boundary line 44 at the apex of the selected building 42.

In step S205, the CPU 11 derives the shortest perpendicular line 45 from the vertex of the selected building 42 to the site boundary line 41, the building 42, or the sidewalk 43.

In step S206, the CPU 11 determines whether or not the derived perpendicular line 45 is equal to or less than the predetermined length. When the derived perpendicular line 45 is equal to or less than a predetermined length (step S206: Yes), the CPU 11 proceeds to step S207. On the other hand, when the derived perpendicular line 45 is not equal to or less than the predetermined length (exceeds the predetermined length) (step S206: No), the CPU 11 proceeds to step S208. Here, the predetermined length related to the perpendicular line 45 is, for example, 1.5 m when the boundary line 44 is set and is, for example, 3 m when the boundary line 44 is not set.

In step S207, the CPU 11 sets the perpendicular line 45 for the vertex of the selected building 42.

In step S208, the CPU 11 determines whether or not processing for setting the boundary line 44 and the perpendicular line 45 has been executed for the vertexes of all buildings 42. When all the vertexes have been processed (step S208: Yes), the CPU 11 ends the boundary line setting processing. On the other hand, when all the vertexes are not processed (there is an unprocessed vertex) (step S208: No), the CPU 11 proceeds to step S201 and selects the vertex of the next building 42.

Next, the candidate estimation processing according to the present embodiment will be described with reference to FIG. 9. FIG. 9 is a flowchart illustrating an example of the candidate estimation processing according to the present embodiment. When the CPU 11 reads and executes a candidate extraction program from the ROM 12 or the storage 14, the candidate extraction program illustrated in FIG. 9 is executed. The supplementary extraction program illustrated in FIG. 9 is executed, for example, when an instruction to execute processing for extracting parking region candidates is input.

In step S301, the CPU 11 selects the region surrounded by the boundary line 41 of the site, the building 42, the sidewalk 43, the boundary line 44, and the perpendicular line 45.

In step S302, the CPU 11 determines whether or not the selected region exceeds a predetermined area. When the area exceeds the predetermined area (step S302: Yes), the CPU 11 proceeds to step S303. On the other hand, when the area does not exceed the predetermined area (the area is equal to or smaller than the predetermined area) (step S302: No), the CPU 11 proceeds to step S305.

In step S303, the CPU 11 determines whether the selected region faces the boundary line 41 (road) of the site or the sidewalk 43. When the region faces the boundary line 41 of the site or the sidewalk 43 (step S303: Yes), the CPU 11 proceeds to step S304. On the other hand, when the region does not face the boundary line 41 of the site or the sidewalk 43 (step S303: No), the CPU 11 proceeds to step S305.

In step S304, the CPU 11 extracts the selected region as the parking region candidate 46.

In step S305, the CPU 11 determines whether or not processing for extracting parking region candidates has been executed for all the regions. When all the regions are processed (step S305: Yes), the CPU 11 ends the candidate extraction processing. On the other hand, when all the regions are not processed (there is an unprocessed region) (step S305: No), the CPU 11 proceeds to step S301 and selects the next region.

As described above, according to the present embodiment, even when the camera and the sensor are not installed in the parking lot, the map information in the parking lot can be created.

In the embodiment, a mode in which the accuracy is estimated and corrected by using each of the detection result of the vehicle 47 and the extraction result of the notification information has been described. However, the present disclosure is not limited thereto. The accuracy may be estimated and corrected in consideration of each weight. For example, when the number of detected vehicles 47 is smaller than a predetermined number in the detection result of the vehicles 47, the accuracy may be corrected by applying a weight value to the correction of the extraction result of the notification information. When the number of pieces of notification information is smaller than a predetermined number in the extraction result of the notification information, the accuracy may be estimated by applying a weight value to the estimation of the detection result of the vehicles 47.

Further, in the embodiment, a mode in which coordinate group information indicating the coordinates of the parking region is output has been described. However, the present disclosure is not limited thereto. Change in the parking region with the lapse of time may be output. For example, the parking region extraction apparatus 10 may acquire a plurality of aerial images 31 as time series data, detects a vehicle 47 from each aerial image 31, derive the accuracy related to each aerial image 31, and output the accuracy of each time series. Accordingly, it is estimated whether the region can be used as a parking lot for each time. For example, when a large number of vehicles 47 are detected, but change with the lapse of time is small, the region may be estimated as a store for the vehicle 47 and an exhibition hall for the vehicle 47. Further, for example, since fixed asset tax is levied as a site on January 1 for each year, the region estimated as the parking region at the beginning of the year or the like has a high accuracy of being a parking region at present. That is, the accuracy may be derived and selected in consideration of change daily, weekly, monthly, or yearly, and for example, an accuracy related to the aerial image 31 photographed at the beginning of the year or the like among a plurality of accuracies derived for each time series is applied.

Further, in the embodiment, a mode in which it is estimated whether or not a region other than the building 42 is a parking region within the target range 40 has been described. However, the present disclosure is not limited thereto. For example, when the vehicle 47 parked on a roof of the building 42 is detected, it may be estimated that the building 42 is a multistory parking lot.

Further, in the embodiment, a mode in which division into the parking region candidates 46 surrounded by the boundary line 41 of the site, the building 42, and the sidewalk 43 is performed has been described. However, the present disclosure is not limited thereto. The parking region candidate 46 may be further divided. For example, when the extracted position of the vehicle 47 is made to correspond to the parking region candidate 46, the area of the parking region candidate 46 may be classified into clusters for the position of the vehicle 47, and the region in which the vehicles 47 are dense may be estimated as a parking possibility region in the parking region candidate 46. Further, a position indicating the estimated parking possibility region may be output as coordinate group information.

In the present embodiment, a mode in which the accuracy is estimated according to the vehicle density related to the parking region candidate 46 has been described. However, the present disclosure is not limited thereto. The accuracy may be estimated according to a parking situation of the vehicle 47. For example, when the vehicle 47 corresponding to the parking region candidate 46 is regularly parked, the accuracy may be estimated to be high. Here, the term regular refers to, for example, a state in which the vehicles 47 are parked at equal intervals, the vehicles 47 are parked along the boundary line 41, the vehicles 47 are parked while facing each other, directions of the vehicles 47 are aligned, and the vehicles 47 are parked at an outer periphery and a center of the region.

Further, in the present embodiment, a mode in which the accuracy is corrected according to the vehicle density of the parking region candidate 46 has been described. However, the present disclosure is not limited thereto. The accuracy may be estimated according to a distribution of the vehicle 47. For example, when the positions of the vehicles 47 are distributed intensively in the vicinity of the building 42 and in the vicinity of the entrance of the site in the vehicle 47 corresponding to the parking region candidate 46, the accuracy may be estimated that the accuracy of the parking region candidate 46 is high.

Furthermore, in the embodiment, a mode in which the map information is polygon information has been described. However, the present disclosure is not limited thereto. For example, when the map information includes identification information for identifying a feature, the boundary line 41 of the site may be set by using the identification information. For example, when information such as “dedicated road in the site”, “park”, and “track” is provided as the identification information, the boundary line 41 of the site may be set in consideration of the identification information. When the identification information includes information on the “dedicated road in the site”, the processing may be performed on assumption that a corresponding location is a road (excluding the parking region candidate) or not included in the setting of the boundary line 44 and the perpendicular line 45.

Further, in the embodiment, a mode in which the vehicle 47 is detected from the aerial image 31 has been described. However, the present disclosure is not limited thereto. A white line, a car pole, a chain gate, a wheel stop, and the like indicating the parking region may be detected from the aerial image 31. For example, the white line, the car pole, the chain gate, and the wheel stop indicating the parking region may be detected from the aerial image 31 and the parking region candidate 46 may be extracted by using a detection result, or the accuracy of the parking region candidate 46 may be estimated. Here, the white line, the car pole, the chain gate, the wheel stop, and the like are examples of a “feature object”.

Further, in the embodiment, a mode in which the parking region candidate 46 is extracted by using the map information 30, and the accuracy of the parking region candidate 46 is estimated by using the aerial image 31 has been described. However, the present disclosure is not limited thereto. The parking region candidate 46 may be extracted by using the aerial image 31, and the accuracy of the parking region candidate 46 may be estimated by using the map information 30.

Further, in the embodiment, a mode in which the parking region candidate 46 is extracted by using the map information 30, and the accuracy of the parking region candidate 46 is estimated by using the aerial image 31 has been described. However, the present disclosure is not limited thereto. The accuracy of the parking region candidate 46 may be derived by extracting the parking region candidate 46 using only the map information, or the accuracy of the parking region candidate 46 may be estimated by extracting the parking region candidate 46 using only the aerial image 31. For example, the parking region candidate 46 may be extracted by using the map information, the area of the parking region candidate 46 may be derived, and the accuracy corresponding to the area may be derived. The accuracy may be derived by extracting the parking region candidate 46 using the aerial image, detecting the vehicle 47 included in the parking region candidate 46, and deriving the vehicle density of the parking region candidate 46.

Further, in the embodiment, a mode in which the perpendicular line 45 is set from the apex of the building 42 to the boundary line 41 of the site and the sidewalk 43 has been described. However, the present disclosure is not limited thereto. A boundary line may be set at the apex of the building 42 from the boundary line 41 of the site and the sidewalk 43. Here, the boundary line to be set is the shortest boundary line among boundary lines set for the apex of the building 42 and the boundary line equal to or less than a predetermined length is set.

Various types of processors other than a CPU may execute the parking region extraction processing that the CPU has read and executed software (program) in each embodiment. In this case, examples of the processor include a programmable logic device (PLD) whose circuit configuration can be changed after manufacturing, such as a field-programmable gate array (FPGA), and a dedicated electric circuit that is a processor having a circuit configuration designed as a dedicated configuration to execute specific processing, such as an application specific integrated circuit (ASIC). Further, the parking region extraction processing may be executed by one of the various processors, or may be executed by a combination of two or more processors of the same or different type (for example, a plurality of FPGAs and a combination of a CPU and an FPGA). Further, more specifically, a hardware structure of these various processors is an electric circuit in which circuit elements such as semiconductor elements are combined.

Further, in each embodiment, an aspect in which the parking region extraction processing program is stored (installed) in the storage 14 in advance has been described, but the present invention is not limited thereto. The program may be provided in an aspect in which the program is stored in a non-transitory storage medium such as a compact disk read only memory (CD-ROM), a digital versatile disk read only memory (DVD-ROM), or a universal serial bus (USB) memory. Further, the program may be downloaded from an external device via a network.

The following appendices are disclosed for the embodiments described above.

### Appendix 1

A parking region extraction apparatus includes
a memory; and
at least one processor connected to the memory,
wherein
the processor
extracts a parking region which is a region for parking a vehicle in a site, and the parking region extraction apparatus is configured to
acquire map information including the site;
divide the site using the map information and extracting candidates for the parking region; and
derive an accuracy of each of the candidates and estimate the parking region.

### Appendix 2

A non-temporary storage medium having a program stored therein, the program being capable of executing processing for extracting a parking region which is a region for parking a vehicle in a site using a computer to execute parking region extraction processing, wherein
the parking region extraction processing includes:
acquiring map information including the site;
dividing the site using the map information and extracting candidates for the parking region;
   and
deriving an accuracy of each of the candidates and estimating the parking region.

### REFERENCE SIGNS LIST

10 Parking region extraction apparatus
11 CPU
12 ROM
13 RAM
14 Storage
15 Input unit
16 Display unit
17 Communication I/F
18 Bus
21 Acquisition unit
22 Target range extraction unit
23 Boundary line setting unit
24 Parking region candidate extraction unit
25 Vehicle detection unit
26 Storage unit
27 Accident extraction unit
28 Estimation unit
30 Map information
31 Aerial image
32 Notification information
33 Coordinate group information
40 Target range
41 Site boundary line
42 Structure
43 Sidewalk
44 Boundary line
45 Perpendicular line
46 Parking region candidate
47 Vehicle

1. A parking region extraction apparatus for extracting a parking region, which is a region for parking a vehicle in a site, the parking region extraction apparatus comprising:
a memory; and
at least one processor coupled to the memory, the at least one processor being configured to:
acquire map information including the site;
extract candidates for the parking region by dividing the site using the map information; and
derive an accuracy of each of the candidates and estimate the parking region.

2. The parking region extraction apparatus according to claim 1, wherein the at least one processor is further configured to:
acquire an aerial image obtained by photographing the site from the sky; and
detect a vehicle included in the site using the aerial image,
wherein the at least one processor derives the accuracy of each of the candidates and estimates the parking region using a detection result of detecting the vehicle.

3. The parking region extraction apparatus according to claim 1, wherein the at least one processor is further configured to:
acquire an aerial image obtained by photographing the site from the sky; and
detect a feature object indicating a parking region included in the site by using the aerial image,
wherein the at least one processor derives the accuracy of each of the candidates and estimates the parking region by using a detection result for the feature object.

4. The parking region extraction apparatus according to claim 1, wherein the at least one processor is further configured to:
acquire notification information indicating an accident involving a vehicle for which notification has been provided in the site,
wherein the at least one processor derives the accuracy by using the notification information.

5. The parking region extraction apparatus according to claim 2, wherein the at least one processor:
acquires a plurality of aerial images indicating time-series data, and
derives at least one of the accuracy corresponding to change related to the time series data or the accuracy for each time series using the time series data.

6. The parking region extraction apparatus according to claim 2, wherein the at least one processor derives the accuracy according to a parking situation of the vehicle as the detection result.

7. The parking region extraction apparatus according to claim 6, wherein the at least one processor derives the accuracy according to a state in which the vehicle is regularly parked as the parking situation.

8. The parking region extraction apparatus according to claim 1, wherein the parking region is extracted by using a feature object indicating a parking region included in the site extracted from an aerial image obtained by photographing the site from the sky, instead of the map information.

9. A parking region extraction method for extracting a parking region that is a region for parking a vehicle in a site, the parking region extraction method comprising causing a computer to execute processing comprising:
acquiring map information including the site;
dividing the site using the map information and extracting candidates for the parking region; and
deriving an accuracy of each of the candidates and estimating the parking region.

10. A non-transitory computer-readable storage medium storing a parking region extraction program for causing a computer to function as the parking region extraction apparatus according to claim 1.
